(19) United States
(12) Patent Application Publication
(10) Pub. No.: US 2026/0056330 A1
(43) Pub. Date: Feb. 26, 2026

(54) METHODS FOR UPDATING GNSS VALIDITY AND MEASUREMENT GAP CONFIGURATION FOR GNSS POSITION FIX PROCEDURES

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 19/105,724

(22) PCT Filed: Feb. 16, 2024
(86) PCT No.: PCT/US2024/016297

§ 371 Date: Feb. 21, 2025

Related U.S. Application Data
(60) Provisional application No. 63/446,323, filed on Feb. 16, 2023.

(51) Int. Cl. G01S 19/46; H04W 56/00; H04W 74/0833

(52) U.S. Cl. CPC G01S 19/46; H04W 56/0045; H04W 74/0833

(57) ABSTRACT

Devices in a wireless communication system perform methods related to a GNSS position fix procedure. A user equipment connected to a network entity via a non-terrestrial network receives a measurement gap configuration and an indication of a remaining-validity-duration-update triggering condition. The UE conducts a GNSS position fix procedure for estimating a UE position during a measurement gap according to the measurement gap configuration. When the GNSS position fix procedure is successfully completed, the UE transmits a remaining GNSS validity duration. When the remaining-validity-duration-update triggering condition is met, the UE transmits an updated remaining GNSS validity duration.

### FIELD OF THE INVENTION

This document generally describes methods and devices operating in wireless communication systems such as (but not limited to) the ones described 3^{rd} Generation Partnership Project (3GPP) technical specifications, known as fifth generation (5G) communication systems. More particularly, embodiments relate to enabling a user equipment (UE) that communicates via non-terrestrial network (NTN) radio access networks (RANs) to conduct Global Navigation Satellite System (GNSS) position fix procedures during configured measurement gaps.

### BACKGROUND

This background description is provided for the purpose of generally presenting the technical context and problems. Work of the presently named inventors, to the extent it is described in this background section, as well as aspects of the description that do not otherwise qualify as prior art at the time of filing, are neither expressly nor impliedly admitted as prior art against the present disclosure.

The 5G technology provides a unified framework for wireless communications including enhanced mobile broadband (eMBB), ultra-reliable low-latency communications (URLLC), and massive machine type communication (mMTC). Augmenting terrestrial networks, 3GPP has expanded communications to NTNs with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, a radio frequency transceiver is mounted on a satellite, an uncrewed aircraft system (UAS, e.g., a drone, a balloon, a plane) or another suitable apparatus. For simplicity, such apparatuses are referred to as satellites. In addition to satellites, an NTN can include one or more satellite-gateways (simpler called “sat-gateways”) that connect the NTN to a public data network, feeder links between sat-gateways and satellites, service links between satellites, and inter-satellite links when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites. A GSO satellite can communicate with one or several sat-gateways deployed over a satellite targeted coverage area (e.g., a region or even a continent). A non-GSO satellite at different times can communicate with one or several serving sat-gateways. An NTN is designed to ensure service and feeder link continuity between successive serving sat-gateways, with sufficient overlapping serving time to proceed with mobility anchoring and handover.

The NB-IoT and eMTC technologies are expected to be particularly suitable for IoT devices operating in remote areas with limited or no terrestrial connectivity. Such IoT devices can be used in a variety of industries including, for example: transportation (maritime, road, rail, air) and logistics; solar, oil, and gas harvesting; utilities; farming; environmental monitoring; and mining. For remote IoT connectivity, satellite connectivity provides coverage beyond terrestrial deployments. Satellite NB-IoT or eMTC is defined in a complementary manner to terrestrial deployments. Satellite NB-IoT or eMTC is defined in a complementary manner to terrestrial deployments.

When connected to a wireless network via an NTN, a UE applies a UE-specific timing advance (TA) to an uplink transmission. The TA compensates for propagation delay between the UE transmitter and a base station (BS) receiver such that the BS receives the uplink transmission via satellite within a desired (scheduled) time window. The UE calculates this TA based on the signal propagation distance between the UE and the BS via the satellite. This distance may change rapidly not only due to the movement of the UE but also the movement of the satellite (or replacing one satellite with another as the case may be).

The UE often calculates this distance using the UE's position assessed based on signals the UE receives from GNSS (using a procedure known as a GNSS position fix) and the satellite's position inferred from satellite ephemeris information (e.g., received in a dedicated system information block (SIB), SIB19). If the UE is unable to perform or to report the GNSS position fix within a GNSS validity duration, the UE switches to an idle state (and may later reconnect after successfully performing and reporting the GNSS position fix). In parallel, the base station (or another network entity (NE)) assumes the UE is in an idle state when the NE fails to receive a GNSS position report within the GNSS validity duration.

Frequent switching between the connected state and the idle state causes significant UE power consumption, which is undesirable, particularly if the UE is a narrowband internet of things (NB-IoT) device that is not able to communicate with the satellite and perform the GNSS position fix simultaneously. The network (i.e., the base station or another NE) may configure measurement gaps for the UE (e.g., an NB-IoT device) to perform the GNSS position fix before the GNSS validity duration ends. However, frequent reconfiguring may occur due to changing conditions for the UE. The UE signaling, to the network, about the changing conditions, followed by the network reconfiguring the measurement gap, adds to power consumption and communication resource usage.

### SUMMARY

The problem of a large volume of signaling associated with keeping up-to-date measurement gaps configuration for GNSS position fix procedures is overcome by the network (i.e., a BS or NE) providing to the UE, triggering condition(s) for the UE to signal an updated GNSS validity duration. The triggering conditions include one or more of (a) a large difference between successive TA values, (b) a large ratio of successive TA values, or (c) an accumulated TA adjustment larger than a threshold.

When the triggering condition(s) for updating the GNSS validity duration has/have been fulfilled, the UE transmits to the network an updated GNSS validity duration. The network may then provide to the UE a dedicated physical random access channel (PRACH) preamble and/or one or more configured UL grants thus enabling the UE to transmit the updated GNSS validity duration. %

Upon receiving an updated GNSS validity duration, the network (i.e., a BS serving the UE or another NE) determines an updated measurement gap configuration for the UE and decides whether to replace the current measurement gap configuration with the updated measurement gap configuration. In view of the decision, the BS may then transmit the updated measurement gap configuration to the UE.

UEs and NEs having each a processor and a transceiver (e.g., a transmitter and a receiver) are configured to perform methods according to these techniques.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a block diagram of a wireless communication system in which a UE and a BS can perform techniques described in the following section.

FIG. 2 is a block diagram of an example NTN node with transparent payload implementation.

FIG. 3 illustrates an LTE user plane protocol stack for use with the architecture of FIG. 2.

FIG. 4 illustrates an LTE control plane protocol stack for use with the architecture of FIG. 2.

FIG. 5A illustrates a timeline of a first background scenario in which a UE switches between the connected state and the idle state in accordance with the GNSS validity status.

FIG. 5B illustrates a timeline of a second background scenario in which a BS provides a UE with a measurement gap configuration, with measurement gaps for the UE to conduct the GNSS position fix.

FIG. 6 illustrates a timeline of a scenario in which the UE signals to the BS a GNSS validity duration update, and the BS configures a new measurement gap in response according to an embodiment.

FIGS. 7A, 7B, and 7C illustrate timelines of scenarios for a UE to report the GNSS validity duration after the end of the GNSS validity period according to various embodiments.

FIG. 8 is a messaging diagram of a scenario in which a UE reports and updates the GNSS validity duration, in order to obtain an up-to-date measurement gap for conducting the GNSS position fix, according to an embodiment.

FIG. 9 is a messaging diagram of a scenario in which a UE fails to conduct the GNSS position fix in a configured measurement gap, and hence a BS assumes the UE is in the idle state upon the expiry of a GNSS reporting timer, according to an embodiment.

FIG. 10 is a messaging diagram of a scenario in which a UE reports the GNSS validity duration via a contention-free random access procedure shortly after a measurement gap, according to an embodiment.

FIG. 11 is a messaging diagram of a scenario in which a UE fails to conduct the GNSS position fix procedure in a measurement gap, and hence the BS transitions the UE in an idle state upon receiving no GNSS validity report from the UE after several UL transmission opportunities, according to an embodiment.

FIG. 12 is a messaging diagram of a scenario in which a UE reports the GNSS validity duration shortly after a measurement gap using an UL transmission grant, according to an embodiment.

FIG. 13 is a flow chart of a UE method for updating the GNSS validity duration and obtaining an updated measurement configuration in the connected state, according to an embodiment.

FIG. 14 is a flow diagram of another UE method for reporting a GNSS validity duration using a contention-free RA procedure according to an embodiment.

FIG. 15 is a flow diagram of yet another UE method for reporting a GNSS validity duration using the UL transmission opportunities, after a measurement gap, according to an embodiment.

FIG. 16 is a flow diagram of an NE method for determining an updated measurement gap configuration for a UE based on an updated GNSS validity duration according to an embodiment.

FIG. 17 is a flow diagram of another NE method for determining whether the UE-specific TA has become inaccurate and whether to update the measurement gap configuration for the UE accordingly, according to an embodiment.

FIG. 18 is a flow diagram of yet another NE method for determining the PRACH resource and a GNSS reporting timer for a UE to report a GNSS validity duration after a measurement gap ends according to an embodiment.

FIG. 19 is a flow diagram of an NE method for providing UL transmission opportunities used by a UE to report a remaining GNSS validity duration after a measurement gap ends according to an embodiment.

### DETAILED DESCRIPTION OF THE DRAWINGS

Methods and devices described in this section embody techniques related to enabling a UE that communicates via an NTN RAN to perform to perform GNSS position fix procedures during inactive periods associated with network configured measurement gaps, and trigger updating of the measurement gap configuration when one or more specific conditions are met. The embodiment descriptions in this section refer to the accompanying drawings. The same reference numbers in different drawings identify the same or similar elements. The detailed descriptions do not preclude other embodiments within the scope of the appended claims (for example, applying one or more methods to another radio access technology than 5G). The embodiments are not limited to the described configurations but may be extended to other arrangements.

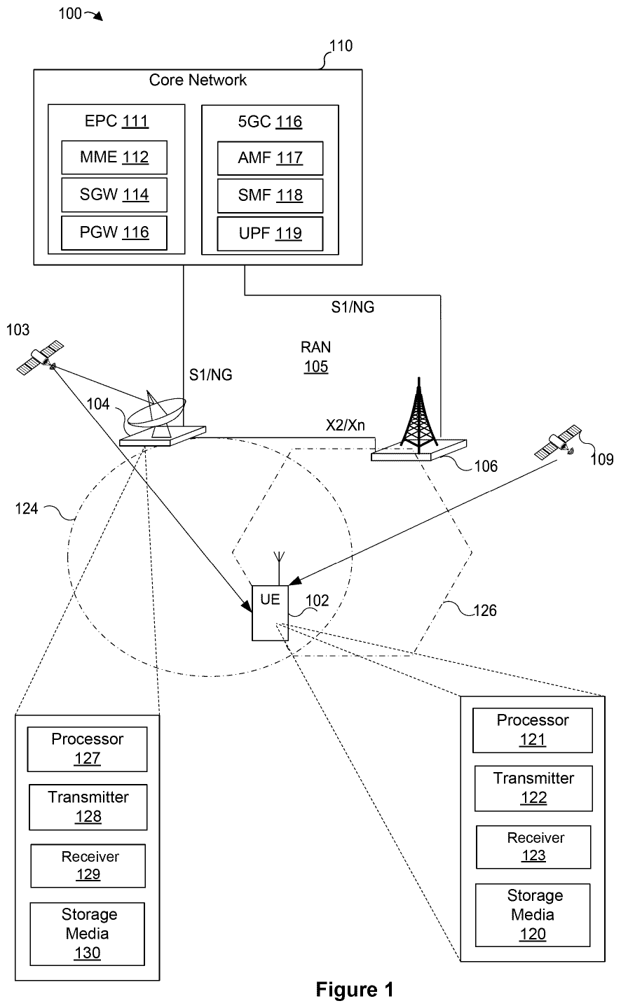

Referring first to FIG. 1, a wireless communication system 100 includes a UE 102, a base station (BS) 104, a BS 106, and a network entity (NE) hosting at least some functions and modules of the CN 110. The BSs 104 and 106 are RAN nodes that operate in a RAN 105 connected to the CN 110. The CN 110 may be an evolved packet core (EPC) 111, a fifth generation (5G) core (5GC) 116 or a CN implementing a different technology such as (but not limited to) a sixth generation (6G) core.

The BS 104 serves a cell 124, and the BS 106 covers a cell 126. If the BS 104 is a gNB, the cell 124 is an NR cell. If the BS 104 is an ng-eNB or eNB, the cell 124 is an evolved universal terrestrial radio access (E-UTRA) cell. Similarly, if the BS 106 is a gNB, the cell 126 is an NR cell, and if the BS 106 is an ng-eNB or eNB, the cell 126 is an E-UTRA cell. The cells 124 and 126 can be in the same Radio Access Network Notification Areas (RNA) or different RNAs. As illustrated in FIG. 1, cell 124 is an NTN cell having an oval footprint. That is, communications to/from BS 104 travel from/to the UE 104 via satellite 103. In contrast cell 124 is a terrestrial network cell. It should be understood that although FIG. 1 shows different types of cells, this is merely an example, the type and number of cells should not be construed as limiting. In general, the RAN 105 can include any number of BSs, and each of the BSs can cover one, two, three, or any other suitable number of cells. The UE 102 supports a 5G NR (or simply, “NR”) or E-UTRA air interface to communicate with the BSs 104 and 106. Each of the BSs 104 and 106 may connect to the CN 110 via an S1 or NG interface. The BSs 104 and 106 may be interconnected via an X2 or Xn interface.

Among other components, the EPC 111 may include a Mobility Management Entity (MME) 112, a Serving Gateway (SGW) 114, and a Packet Data Network Gateway (PGW) 116. The MME 112 is configured to manage authentication, registration, paging, and other related functions. The SGW 112 in general is configured to transfer user-plane packets related to audio calls, video calls, Internet traffic, etc. The PGW 116 provides connectivity from a UE to one or more external packet data networks, e.g., an Internet network and/or an Internet Protocol (IP) Multimedia Subsystem (IMS) network. The 5GC 116 includes an Access and Mobility Management Function (AMF) 117, a Session Management Function (SMF) 118, and a User Plane Function (UPF) 119. The AMF 117 is configured to manage authentication, registration, paging, and other related functions, the SMF 117 is configured to manage PDU sessions, and the UPF 119 is configured to transfer user-plane packets related to audio calls, video calls, Internet traffic, etc. The EPC 111 may include other modules than the ones illustrated in FIG. 1, and the 5GC 116 may include other and more functions than the ones illustrated in FIG. 1. The EPC modules and/or 5GC functions are hosted by one or more wireless and/or wired communication devices including processors.

As illustrated in FIG. 1, the BS 104 supports a cell 124, and the BS 106 supports a cell 126. The cells 124 and 126 can partially overlap, so that the UE 102 can select, reselect, or hand over from one of the cells 124 and 126 to the other. To directly exchange messages or information, the BS 104 and BS 106 can support an X2 or Xn interface. In general, the CN 110 can connect to any suitable number of BSs supporting NR cells and/or EUTRA cells.

As discussed in detail below, the UE 102 and/or NEs of the RAN 105 may use various methods described in this section when the radio connection between the UE 102 and the RAN 105 is suspended (e.g., when the UE 102 operates in an inactive or idle state of the protocol for controlling radio resources between the UE 102 and the RAN 105). For clarity, the examples below refer to the RRC_INACTIVE or RRC IDLE state of the RRC protocol. The UE 102 (e.g., a specialized GNSS module thereof) can estimate its current position using signals received from GNSS satellites such as satellite 109 (typically the UE receives plural GNSS signals, for example, 5 or more).

The UE 102 is equipped with processing hardware that includes one or more general-purpose processors and/or special-purpose processing units 121, and a non-transitory computer-readable memory 120 storing device data and/or machine-readable instructions executable on the processor 121. The processor 121 prepares uplink (UL) data that the UE 102 transmits in the UL direction and/or processes downlink (DL) data the UE receives in the DL direction. The UE processing hardware also includes a transmitter 122 configured to transmit UL data and a receiver 123 configured to receive data in the uplink direction or other hardware that enables UE's wireless communication and may be collectively named “transceiver.”

The BS 104 is equipped with processing hardware that includes one or more general-purpose processors or special-purpose processing units 127 and a non-transitory computer-readable memory 130 storing device data and/or instructions that the processor 127 may execute. The BS 104 includes a processor 127 to prepare DL data that the BS 104 transmits in the DL direction, and/or to process UL data the BS 104 receives in the UL direction. The processing hardware may also include a transmitter 128 configured to transmit DL data and a receiver 129 configured to receive UL data (or other equivalent hardware collectively named “transceiver”). The BS 106 can include generally similar components.

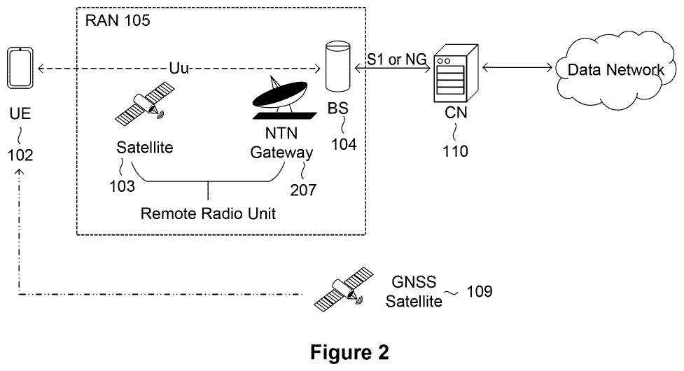

FIG. 2 illustrates an NTN arrangement representing a certain type of NTN deployment referred to as a transparent payload architecture, which involves a satellite gateway 207 and a “transparent” satellite 103. The satellite 103 implements a frequency conversion and an radio frequency amplifier in both the UL and DL directions. The satellite operates in a manner similar to that of an analogue RF repeater. As a result, the satellite 103 repeats signals received via a feeder link (between the NTN gateway 207 and the satellite 103) to the service link (between the satellite 103 and the UE 102) in the DL direction and vice versa in the UL direction. The Satellite Radio Interface (SRI) on the feeder link is the Uu, and the NTN gateway 207 supports all necessary functions to forward the signals of the Uu interface. The NTN gateway 207 may be collocated with the BS 104 or may be connected to the BS 104 via a wired link. The BS 104 may be connected to more than one NTN gateway. Different transparent satellites may be connected to the same BS on the ground, via the same NTN gateway, or via different NTN gateways. The UE 102 also receives signals from one or more GNSS satellites such as satellite 109. Note that GNSS radio signals travel on a substantial straight path from the GNSS Satellite 109 to the UE as illustrated in FIG. 1, while the line in FIG. 2 merely suggests that GNSS signal reaches the UE 102 but is not meant to represent the signal path.

Although the transparent payload architecture illustrated in FIG. 2 is the current focus of the 3GPP development, the regenerative payload architecture that installs the eNB functions on the satellite is a foreseeable future NTN deployment. In such an architecture, the Uu only exists between the satellite and the UE. However, the methods described in this section are usable for the transparent payload architecture as well as the regenerative payload architecture.

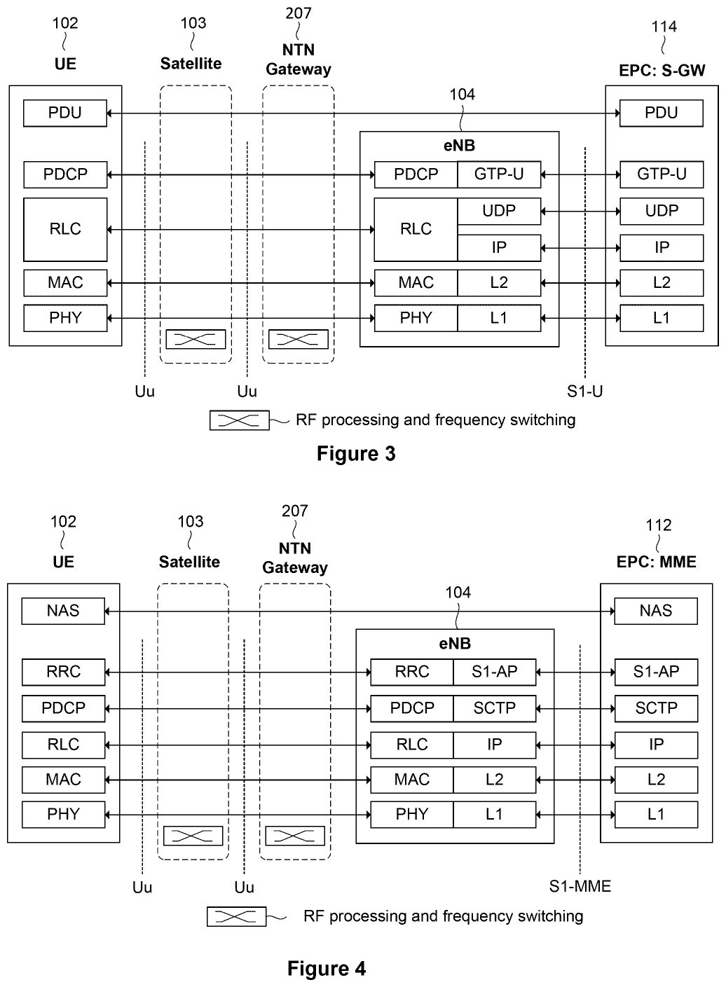

The NTN user plane protocol stack (of the transparent payload architecture) involving the UE 102, the satellite 103, the NTN gateway 207, the eNB 104, and the SGW 114 is illustrated in FIG. 3. Although FIG. 3 shows an LTE protocol stack, the NTN-related aspects apply to 5G as well with the RAN 104 being a gNB and the SGW being replaced by and UPF. The diagram of the NTN user plane protocol stack is similar to that of the terrestrial network (TN), with the addition of two new nodes, the satellite 103 and the NTN gateway 207, being placed in the middle of the Uu interface. A physical layer (PHY) of EUTRA provides transport channels to the EUTRA MAC sublayer, which in turn provides logical channels to the EUTRA RLC sublayer. The EUTRA RLC sublayer then provides RLC channels to an EUTRA PDCP sublayer and, in some cases, to an NR PDCP sublayer. The PDCP sublayer in turn can provide data transfer services to Service Data Adaptation Protocol or a radio resource control (RRC) sublayer (not shown). The UE 102, in some implementations, supports both the EUTRA and the NR stack, thereby supporting a handover between EUTRA and NR BSs and/or a dual connectivity over EUTRA and NR interfaces. The EUTRA PDCP sublayer and the NR PDCP sublayers receive packets (e.g., from an Internet Protocol (IP) layer, layered directly or indirectly over the PDCP layer) that can be referred to as service data units (SDUs), and output packets (e.g., to the RLC layer) that can be referred to as protocol data units (PDUs). Except where the difference between SDUs and PDUs is relevant, this disclosure for simplicity refers to both SDUs and PDUs as “packets.”

The NTN control plane protocol stack illustrated in FIG. 4 is also similar to that of the TN. On the control plane, the EUTRA PDCP sublayer and the NR PDCP sublayer can provide signaling radio bearers or RRC sublayer to exchange RRC messages or non-access-stratum (NAS) messages, for example. On a user plane, the EUTRA PDCP sublayer and the NR PDCP sublayer can provide Data Radio Bearers (DRBs) to support data exchange. Data exchanged on the NR PDCP sublayer can be SDAP PDUs, Internet Protocol (IP) packets or Ethernet packets. Although FIG. 4 shows an LTE protocol stack, the NTN-related aspects apply to a 5G protocol as well with the RAN 104 being a gNB and the MME being replaced by and AMF.

In terms of the satellite moving pattern, there are three types of service links that are supported in NTN:
Earth-fixed: provisioned by beam(s) continuously covering the same geographical areas all the time (e.g., the case of GEO/GSO satellites)
Quasi-Earth-fixed: provisioned by beam(s) covering one geographic area for a limited period and a different geographic area during another period (e.g., the case of LEO/MEO satellites capable of using steerable beams)
Earth-moving: provisioned by beam(s) whose coverage area slides over the Earth surface (e.g., the case of LEO/MEO satellites using fixed or non-steerable beams).

With LEO/MEO satellites, the eNB can provide either quasi-Earth-fixed cell coverage or Earth-moving cell coverage. With GEO satellites, the eNB can provide Earth fixed cell coverage.

Whenever transmitting any signal/data to a BS in the UL direction, each UE has to apply a UE-specific TA that is calculated based on the distance between the UE and the connected satellite, so that all the UL transmissions can arrive precisely at desired timing scheduled by the BS. Hence every UE needs to keep tracking its own position as well as the position of the connected satellite. To avoid interfering with other UEs or the BS, a UE is not allowed to perform any UL transmission without a valid UE position or a valid satellite position information. As a UE position may become invalid after a certain period of time (depending on UE's mobility), a UE may need to periodically acquire its GNSS position from the GNSS module in order to continue performing the UL transmissions to the BS (as described, for example, in 3GPP TS 36.331). The UE obtains its valid GNSS position before connecting to an NTN cell and moves to the idle state if the GNSS position is outdated. As previously mentioned, an NB-IoT device (UE) is not able to perform simultaneously radio communication with the BS and a GNSS position fix procedure.

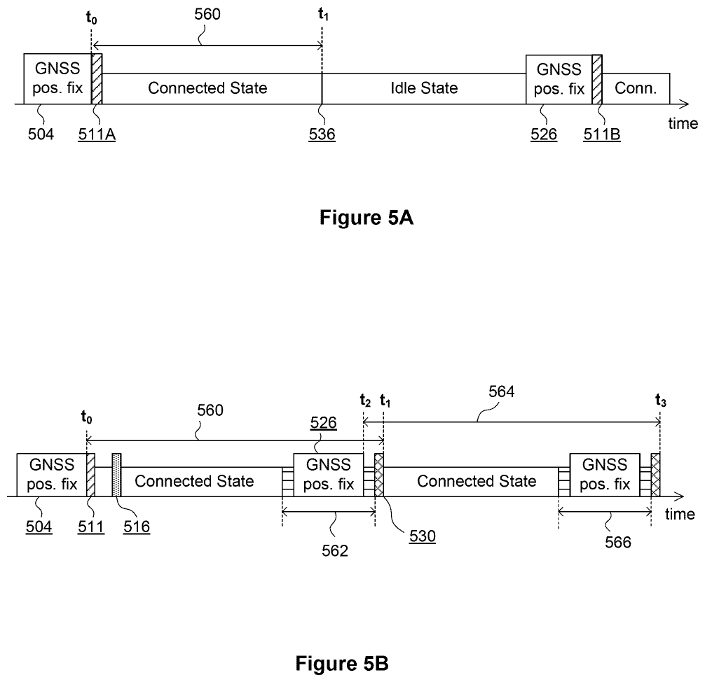

FIGS. 5A and 5B are timelines (times flowing from left to right) of scenarios illustrating conventional (e.g., Rel 17) UE's behavior related to GNSS-based position validity (i.e., UE's GNSS-based position is valid for a GNSS validity duration). In these figures action labels are underlined while time interval labels are not. FIG. 5A is a timeline of a first background scenario in which a UE switches between the connected state and the idle state in accordance with the GNSS validity status. In order to communicate with the BS, the UE conducts a GNSS position fix procedure 504 and obtains its GNSS-based position together with a GNSS validity duration 560 from UE's GNSS module. The GNSS validity duration indicates how long (from t₀ to t₁ in this example) the GNSS-based position obtained using the GNSS position fix procedure remains valid. After obtaining its position, the UE performs 511A an RRC Connection Establishment procedure with the BS. The UE reports, to the BS, a current remaining GNSS validity duration during the RRC Connection Establishment procedure. Here and as described later in other situations, the UE reports the remaining GNSS validity duration as soon as feasible after the GNSS position fix procedure is successfully completed so that the UE and the BS have a common understanding of the end of the GNSS validity duration.

After the RRC Connection Establishment procedure is completed, the UE is in the connected state until the GNSS validity duration expires (t₁ in this example). Upon the expiry of the GNSS validity duration, the UE switches 536 to the idle state and the BS also transitions the UE to the idle state at the same time, both UE and BS having the same understanding with regard to when UE's GNSS validity duration expires. After that, in order to re-establish communication with the BS, the UE conducts again the GNSS position fix procedure 526 to obtain its GNSS-based position and performs another RRC Connection Establishment procedure 511B.

In the scenario illustrated in FIG. 5A, the UE switches between the idle and connected states. UE's state switching requires a substantial amount of overhead signaling and power. 3GPP has recently adopted some techniques to reduce UE's switching between RRC states related to conducting the GNSS position fix and updating the GNSS validity duration. FIG. 5B illustrates one of these techniques. This figure represents a timeline of a second background scenario in which a BS provides 516, to the UE, a measurement gap configuration. A measurement gap 562 according to the measurement gap configuration is scheduled to enable the UE to timely conduct the GNSS position fix procedure 526 (e.g., when the GNSS validity duration is close to expiration). The use of a measurement gap enables the UE to remain in the connected state during a second GNSS validity duration 564 if the GNSS position fix procedure performed during measurement gap 562 has been successful, thus avoiding the overhead and power consumption problem. The UE reports 530 the remaining GNSS validity duration and performs another GNSS fix procedure in a measurement gap 566 before the end of the second GNSS validity duration 564.

However, in order to appropriately schedule the measurement gaps, the BS relies on the up-to-date validity duration. This BS's reliance on often receiving an indication of the GNSS validity duration 530 causes additional overhead and potential problems if the UE is at times not able to report the remaining GNSS validity duration. Moreover, as each measurement gap is determined or configured statically by the BS, by the time the UE reports the remaining GNSS validity duration, the determined/configured measurement gap may no longer suit UE's situation as the GNSS validity duration may have changed due, for example, to a change of UE's mobility (e.g., changing from low-mobility to high-mobility). Therefore, it is apparent that the technique employing measurement gaps needs improvement.

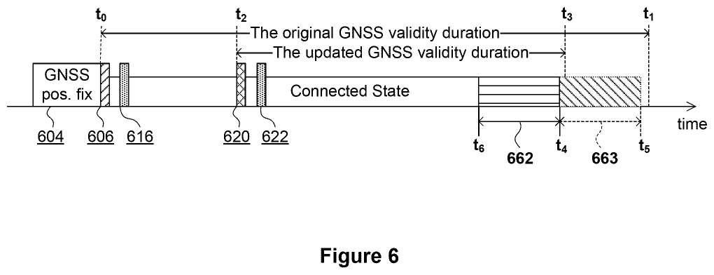

FIG. 6 illustrates a timeline of a scenario in which the UE signals to the BS a GNSS validity duration update, and the BS configures a new measurement gap in response according to an embodiment. The UE conducts a GNSS position fix procedure 604 (similar to 504) obtaining its GNSS-based position and a GNSS validity duration as previously described. The UE then establishes an RRC connection with a BS by sending 606 an RRC Connection Request message to the BS, where the RRC Connection Request message includes a remaining GNSS validity duration expiring at t₁. As described in this example, the UE uses an RRC Connection Request message during an RRC connection establishment procedure to convey its GNSS-based position and a GNSS validity duration 560. Other implementations may use alternative messages, such as an RRC Connection Setup Complete message, exchanged during an RRC connection establishment procedure to convey the UE's GNSS-based position and a GNSS validity duration 560.

The UE later receives 616 from the BS an RRC Connection Reconfiguration message including a measurement gap configuration. This message also conveys one or more triggering conditions which after being met, cause the UE to transmit to the BS an update of the GNSS validity duration (that is a remaining GNSS validity duration that changes an end time of the GNSS validity duration). Absent a message updating the end time of the GNSS validity duration, the BS operates based on the assumption that the GNSS validity duration from t₀ to t₁ lasts longer than a next scheduled (configured) measurement gap 663 from t₄ to t₅ (that is, t₅<t₁).

In one embodiment, the triggering condition is met when the UE receives from the BS a Timing Advance Command (TAC) containing a Timing Advance (TA) adjustment value larger than a TA threshold value. The TA threshold value may also be provided by the BS. In another embodiment, the triggering condition is met when a number of TACs the UE receives from the BS in a given time interval exceeds a threshold number k. The number of TACs and the given time interval may also be provided by the BS. Yet in another embodiment, the triggering condition is met when UE's accumulated TA adjustment value (e.g., the N_{TA} defined in 3GPP TS 36.211) exceeds an accumulated TA threshold value. The accumulated TA threshold value may be provided by the BS. These and other triggering conditions trigger the UE to notify the BS. A triggering condition is designed to flag when the UE-specific TA has or is becoming less accurate. Thus, example triggering conditions focus on the UE receiving, from the BS, TAC(s) with a large TA adjustment value, a substantial accumulated TA adjustment, or more frequent TA adjustments.

During a measurement gap, the UE does not engage with the BS for any communication (i.e., does not transmit or receive messages), and instead initiates a GNSS position fix procedure before the end of the measurement gap. The UE performs this GNSS position fix procedure early enough to obtain the UE's current position and an associated GNSS validity time interval before the GNSS validity duration timer expires. However, when the triggering condition(s) is met, the UE sends 620 at t₂ an updated remaining GNSS validity duration ending at t₃ to the BS, t₃ being earlier than t₆. In response to receiving the updated GNSS validity duration, the BS transmits 622 an updated measurement gap configuration to the UE, which configures a new measurement gap 662 starting at t₆ and ending at t₄ which is before t₃ and earlier than the initially scheduled measurement gap from t₄ to t₅.

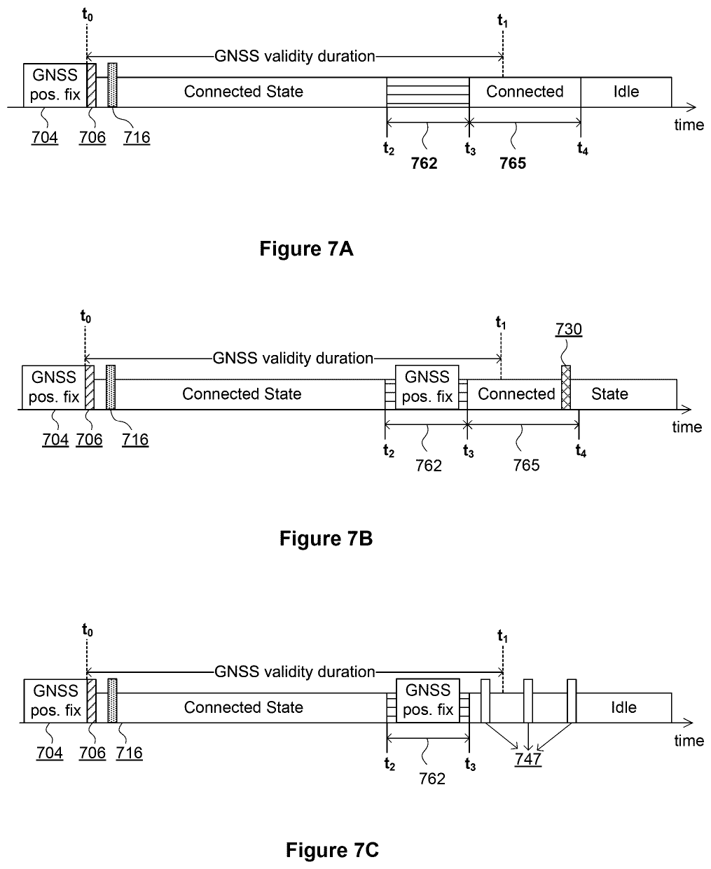

FIGS. 7A, 7B, and 7C are timelines of scenarios for a UE to report the remaining GNSS validity duration after the end of a measurement gap according to various embodiments. These timelines illustrate two techniques for a UE to report the remaining GNSS validity duration after the end of a measurement gap: a first technique (used in the scenarios in FIGS. 7A and 7B) is based on a GNSS report timer, and a second technique (used in the scenario in FIG. 7C) is based on a UL transmission opportunities counter. These techniques can be used after any measurement gap (e.g., original or adjusted).

In FIG. 7A, a UE first conducts 704 (similar to 604) a GNSS position fix procedure (for obtaining UE's GNSS-based position and an associated GNSS validity duration), and then establishes a connection with a BS by sending 706 (which is similar to 606) an RRC Connection Request message to the BS. The RRC Connection Request message includes a remaining GNSS validity duration expiring at t₁. In response to receiving the remaining GNSS validity duration, the BS transmits 716 (which is similar to 616), to the UE, a message including a measurement gap configuration and an indication of a dedicate physical random access channel (PRACH) resource (e.g., a dedicated PRACH preamble) usable by the UE for reporting an updated remaining GNSS validity duration. The indication may be included in the measurement gap configuration or may be part of the message in addition to the measurement gap configuration. According to the measurement gap configuration, a measurement gap 762 starts at t₂ and lasts until t₃ (t₃<t₁).

The UE initiates a GNSS position fix procedure after the beginning t₂ of the measurement gap. Immediately after the end of the measurement gap (i.e., at t₃), the UE starts a GNSS reporting timer. The GNSS reporting timer may be set to measure a fixed predefined time interval 765, or another time interval indicated by the BS with or within the measurement gap configuration. In one embodiment, the dedicated PRACH resource indicated to the UE is available until the GNSS reporting timer expires.

In FIG. 7A, the UE is not able to report its GNSS validity duration to the BS while the GNSS reporting timer is running. Hence, the UE transitions to the idle state upon the expiry of the GNSS reporting timer (at t₄). A reason for not being able to report the GNSS validity duration could be the UE failing to successfully conduct a GNSS position fix, or the UE failing to complete the random access procedure for reporting the remaining GNSS validity duration before the end of the GNSS reporting time interval 765 (measured by the GNSS reporting timer), which is at t₄.

The scenario in FIG. 7B is similar to that in FIG. 7A, but the UE in FIG. 7B is able to report 730 the remaining GNSS validity duration to the BS before the GNSS reporting timer expires at t₄. Therefore, the UE remains in the connected state after the GNSS reporting timer expires.

FIG. 7C illustrates another technique for UE to report the GNSS validity duration after the measurement gap 762 (similar to 662). Here, the BS proactively provides 747 a number of UL transmission opportunities (i.e., UL grants) after the end of the measurement gap 762. When the UE transmits a GNSS validity duration during one of these UL transmission opportunities 747, the UE maintains its RRC_connected state. When the UE fails to use any of these opportunities, the UE transitions to the idle state after the last of the UL transmission opportunities.

In one embodiment, the BS informs the UE of how many UL transmission opportunities will be provided, for example, by including their number in the measurement gap configuration or in the message 716 sent to the UE. In another embodiment, the number of the UL transmission opportunities is fixed and known by both the UE and the BS.

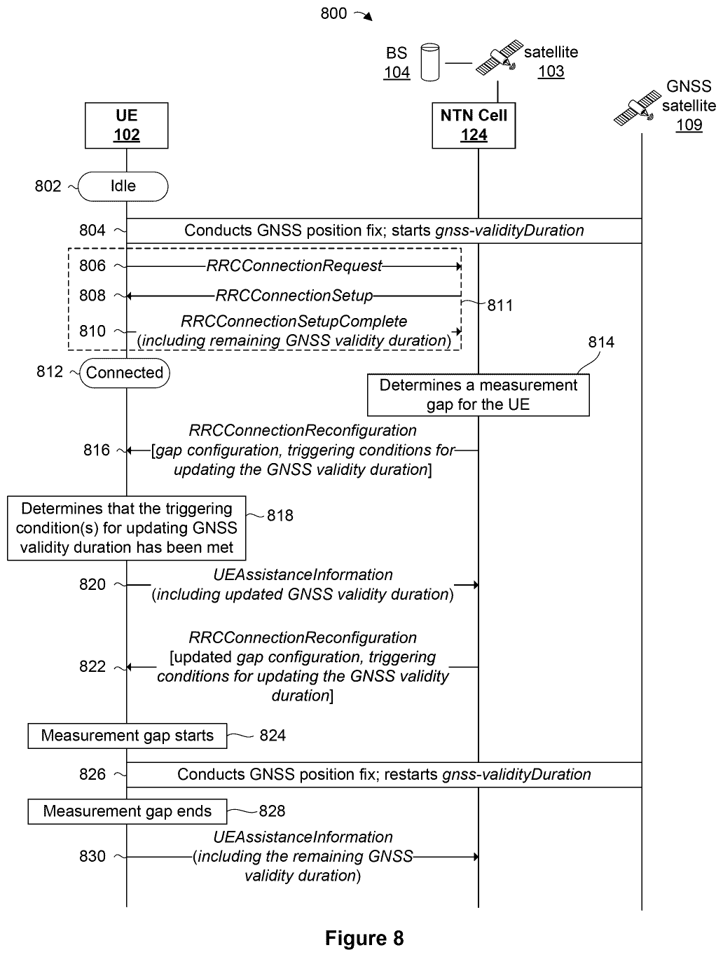

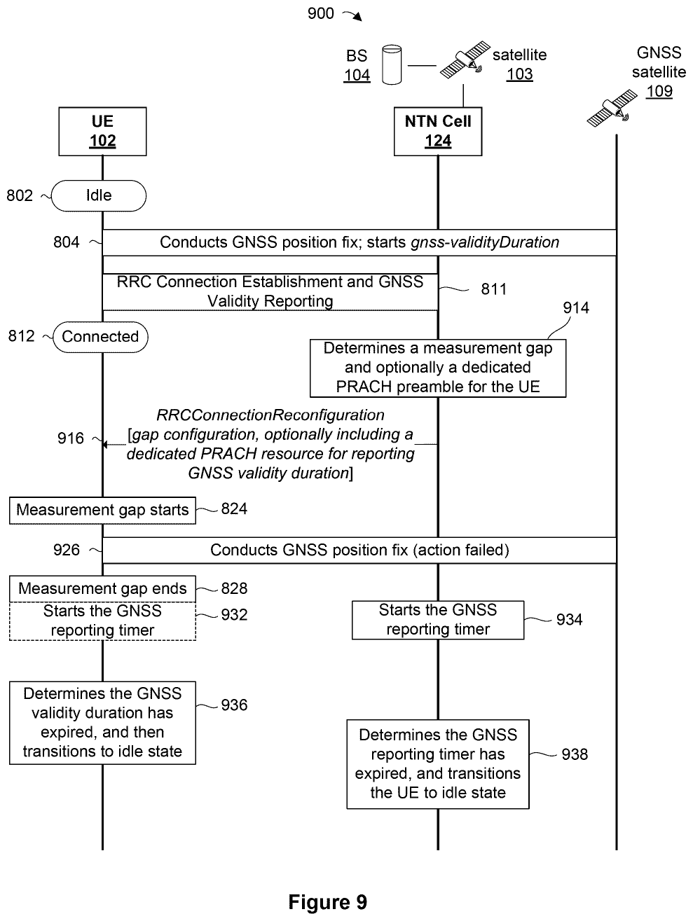

FIGS. 8-12 are messaging diagrams illustrating UE and NE behavior according to various embodiments and different scenarios. Similar actions in FIGS. 8-12 are labeled with the similar reference numbers, with differences discussed below where appropriate. For example, event 814 is similar to event 914/1114, event 816 is similar to event 916/1116, and event 830 is similar to event 1030/1230. Time flows from top to bottom of these figures; that is, actions represented higher on the page occur earlier than the ones represented lower therein.

FIG. 8 is a messaging diagram 800 of a scenario in which a UE reports and updates the GNSS validity duration, in order to obtain an up-to-date measurement gap for conducting the GNSS position fix, according to an embodiment. FIG. 8 corresponds to the timeline illustrated in FIG. 6. A UE 102 is initially 802 in the idle state and camps on the NTN cell 124 managed by the BS 104, via the service link provided by the satellite 103. Similar to event 604, the UE 102 then conducts 804 a GNSS position fix procedure estimating UE's position based on GNSS signals received from GNSS satellites (e.g., GNSS satellite 109). The UE 102 may conduct 804 the GNSS position fix procedure upon receiving a demand from upper layer(s) for establishing the connection with the BS 104. Upon successfully conducting the GNSS position fix procedure, the UE starts a GNSS validity duration timer to measure the GNSS validity duration. Similar to event 606, the UE 102 then transmits 806 an RRC Connection Request message to the BS 104 for establishing the RRC connection with the BS 104 via satellite 103. In response to the RRC Connection Request message, the BS 104 transmits 808 an RRC Connection Setup message to the UE 102, for establishing the SRB1 (Signaling Radio Bearer 1). Following the reception of the RRC Connection Setup message, the UE 102 transmits 810 an RRC Connection Setup Complete message to the BS, and then transitions to the connected state 812. The RRC Connection Setup Complete message includes the remaining GNSS validity duration (based on gnss-validityDuration timer). The events 806, 808, and 810 are collectively referred to as a procedure for “RRC connection establishment and GNSS validity reporting” 811 in FIGS. 8 and 9-12.

In view of the remaining GNSS validity duration reported by the UE 102, the BS 104 determines 814 a measurement gap configuration for the UE 102, and then transmits 816 (which is similar to event 616) an RRC message (e.g., an RRCConnectionReconfiguration message) including the measurement gap configuration to the UE 102. The measurement gap configuration may include a measurement gap length value, a measurement gap offset value, and a measurement gap repetition period. The BS 104 configures each measurement gap to end before a corresponding GNSS validity duration(s) expires. The BS 104 also transmits, together with the measurement gap configuration, the triggering condition(s) for updating the remaining of GNSS validity duration. The triggering condition(s) may use triggering condition parameters. For example, the triggering conditions(s) parameters may include a TA adjustment threshold value, the trigger condition being met when a TA adjustment value received by the UE within a TAC from the BS 104 exceeds the TA adjustment threshold value. In another example, the triggering conditions(s) parameters include a threshold number k and a given time interval, the trigger condition being met when the UE 102 receives more than k TACs from the BS 104 in the given time interval. In yet another example, the triggering conditions(s) parameters may include a TA accumulated adjustment threshold value, the trigger condition being met when UE's accumulated TA adjustment value (e.g., the NTA defined in 3GPP TS 36.211) exceeds the TA accumulated adjustment threshold value. The triggering condition may include different alternative prongs or a combination of prongs.

After receiving 816 the measurement gap configuration and the triggering condition(s) for updating the remaining GNSS validity duration, the UE 102 determines 818 that the triggering condition(s) for updating remaining GNSS validity duration is(are) met. Similar to event 620, the UE 102 then transmits 820 an UL DCCH message (e.g., UEAssistanceInformation message) including an updated remaining GNSS validity duration value to the BS 104. In response to receiving the updated remaining GNSS validity duration, the BS 104 transmits 822 (which is similar to event 622) an RRC Connection Reconfiguration message including an updated measurement gap configuration to the UE 102. The RRC Connection Reconfiguration message may also include updated triggering condition(s) for updating the remaining GNSS validity duration. According to the updated measurement gap configuration, the previously configured measurement gap (e.g., 663 in FIG. 6) is replaced by a newly configured measurement gap (662 in FIG. 6).

The UE 102 suspends its cellular communication at the beginning 824 of the measurement gap and maintains this suspension throughout the duration of the measurement gap. The UE 102 then conducts 826 a GNSS position fix procedure during the measurement gap and restarts the gnss-validityDuration timer if the GNSS position fix procedure yields a valid GNSS-based position for the UE 102. The UE 102 starts the GNSS position fix procedure during the measurement gap in a manner to anticipate completing it before the end of the measurement gap.

After the measurement gap ends 828, the UE 102 resumes its wireless communications with the BS 104. The UE 102 then transmits 830 (similar to 730) an UL DCCH message (e.g., UEAssistanceInformation) including the remaining GNSS validity duration (based on the gnss-validityDuration timer's current value) to the BS 104. The UL DCCH message may use an uplink grant obtained via a RA procedure or one of the uplink opportunities (i.e., grants) provided by the BS as in FIG. 7C.

FIG. 9 is a messaging diagram 900 of a scenario in which (as in FIG. 7A) a UE fails to conduct the GNSS position fix in a configured measurement gap, and hence a BS assumes the UE is in the idle state upon the expiry of a GNSS reporting timer, according to an embodiment. FIG. 9 is similar to FIG. 8, with the differences discussed below. After performing 811 the procedure for RRC connection establishment and GNSS validity reporting, the BS 104 determines 914 a measurement gap configuration and a dedicated PRACH resource (e.g., a dedicated PRACH preamble) for the UE 102. The BS 104 then transmits 916 an RRC message (e.g., an RRCConnectionReconfiguration message) including the measurement gap configuration and an indication for the dedicated PRACH resource to the UE 102. The BS 104 may determine the measurement gap configuration based on the remaining GNSS validity duration reported by the UE 102. In one embodiment, the BS 104 also determines a GNSS reporting timer value for the UE 102 and transmits 916 this GNSS reporting timer value to the UE 102. In another embodiment, the GNSS reporting timer value is a common value to all the UEs. Yet in another embodiment, the GNSS reporting timer value is a common configurable value that is broadcasted in a SIB (e.g., SIB31). In one embodiment, the dedicated PRACH resource indicated to the UE is only available for a certain period of time, and this period of time equals to the GNSS reporting timer value or ends when the GNSS reporting timer expires.

In this scenario, the GNSS position fix procedure that the UE 102 conducts 926 during the measurement gap is not successful. The GNSS position fix procedure may fail because the GNSS signals are blocked by obstacles, or the UE 102 is unable to complete the GNSS position fix procedure in the available time (i.e., before the end of the measurement gap).

After the measurement gap ends 828, the UE 102 resumes its cellular communication tasks. The BS 104, which is unaware of the GNSS position fix procedure's failure, starts 934 a GNSS reporting timer for the UE 102 when the measurement gap ends. The UE 102 may also similarly start 932 its GNSS reporting timer at the same time and using the same initial value (i.e., to measure the same GNSS reporting time interval). Because the GNSS position fix procedure was unsuccessful, when the GNSS validity duration expires 936, the UE 102 transitions to the idle state. On the BS side, the BS transition 938 the UE 102 into the idle state when the GNSS validity duration timer expires (which may be later than event 936) without the BS 104 receiving a remaining GNSS validity duration from the UE 102. In one embodiment, the BS 104 transitions the UE 102 into the idle state if either the GNSS validity duration timer or the GNSS reporting timer expires. In another embodiment, the BS 104 transitions the UE 102 into the idle state if both the GNSS validity duration timer and the GNSS reporting timer expire.

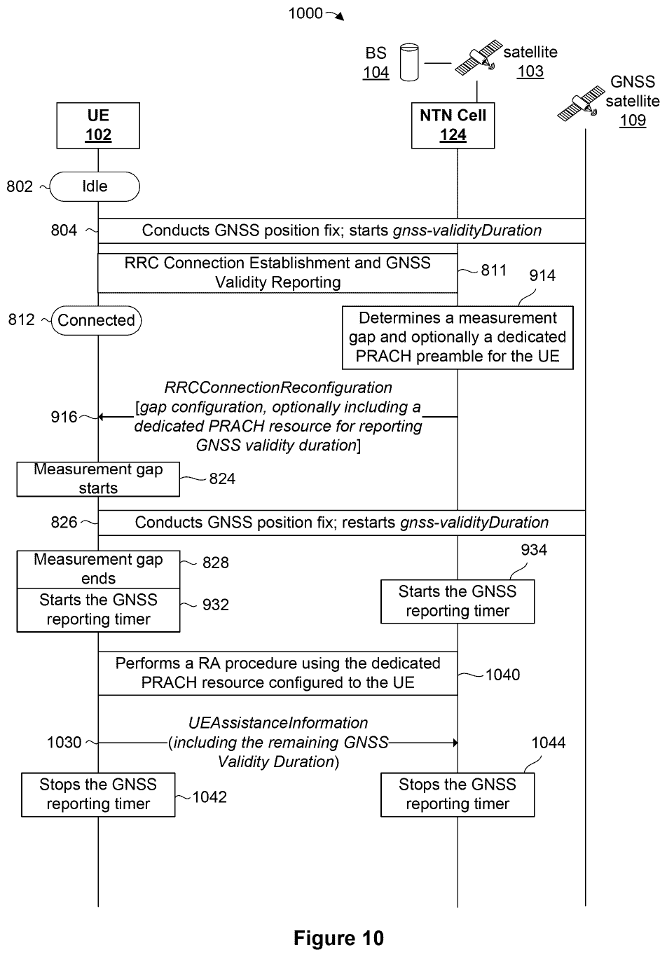

FIG. 10 is a messaging diagram 1000 of a scenario in which a UE reports the remaining GNSS validity duration (as in FIG. 7B) via a contention-free random access procedure shortly after the measurement gap ends, according to an embodiment. The message diagram in FIG. 10 is similar to that in FIG. 9, with the differences discussed below. According to the measurement gap configuration that the BS has provided 916 to the UE, the UE 102 suspends 824 its cellular communication tasks at the beginning of the measurement gap. The UE 102 then conducts 826 a GNSS position fix procedure during the measurement gap and starts the gnss-validityDuration timer upon successfully completing the GNSS position fix procedure.

After the end 828 of measurement gap, the UE 102 resumes its cellular communications with the BS 104. The BS 104 starts 934 a GNSS reporting timer related to the UE 102 at the end of the measurement gap, and the UE 102 simultaneously starts 932 a similar GNSS reporting timer with the same timer value. As the GNSS position fix procedure was successful, the UE 102 initiates 1040 a contention-free random access procedure in order to obtain an UL transmission opportunity. That is, the UE 102 sends to the BS 104, the dedicated PRACH resource (e.g., the dedicated PRACH preamble) indicated in the RRC message the BS transmitted 916 to the UE. Upon obtaining an UL transmission opportunity from the BS 104, the UE 102 transmits 1030 the remaining GNSS validity duration (based on a current value of the GNSS validity duration to the BS 104 via an UL DCCH message (e.g., UEassistanceInformation). Because the UE 102 informs the BS 104 of its remaining GNSS validity duration before the GNSS reporting timer expires, both the UE 102 and BS 104 stop 1042/1044 their respective GNSS reporting timers related to the UE. In one embodiment, the UE 102 resumes its cellular communication with the BS 104 before the measurement gap ends 828, after the UE 102 has completed the GNSS position fix procedure. In such an embodiment, the UE 102 may perform 1040 the contention-free random access procedure even before the measurement gap ends 828 (i.e., before the UE 102 starts 932 the GNSS reporting timer).

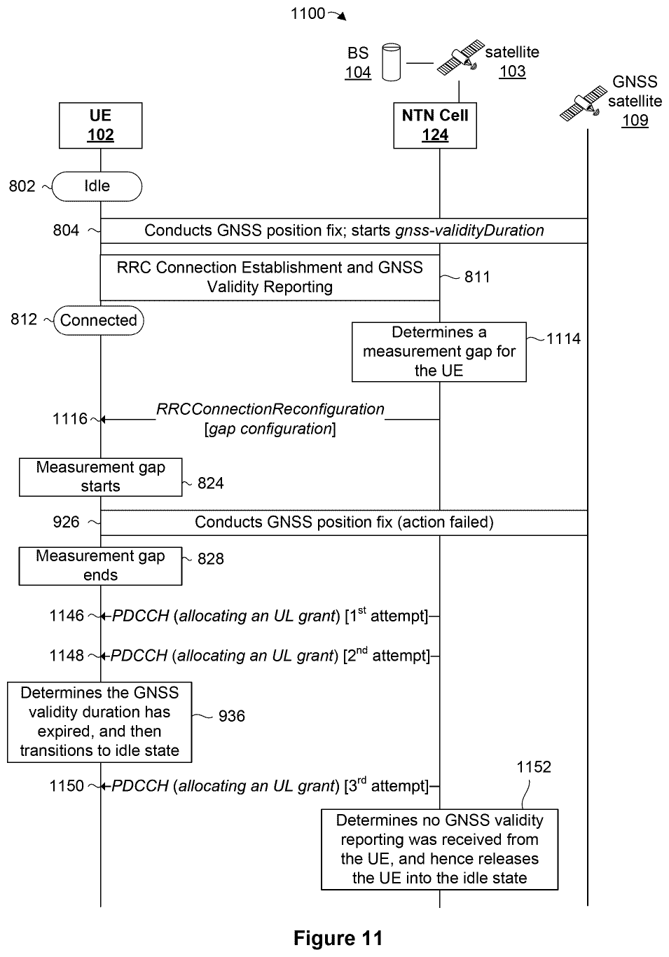

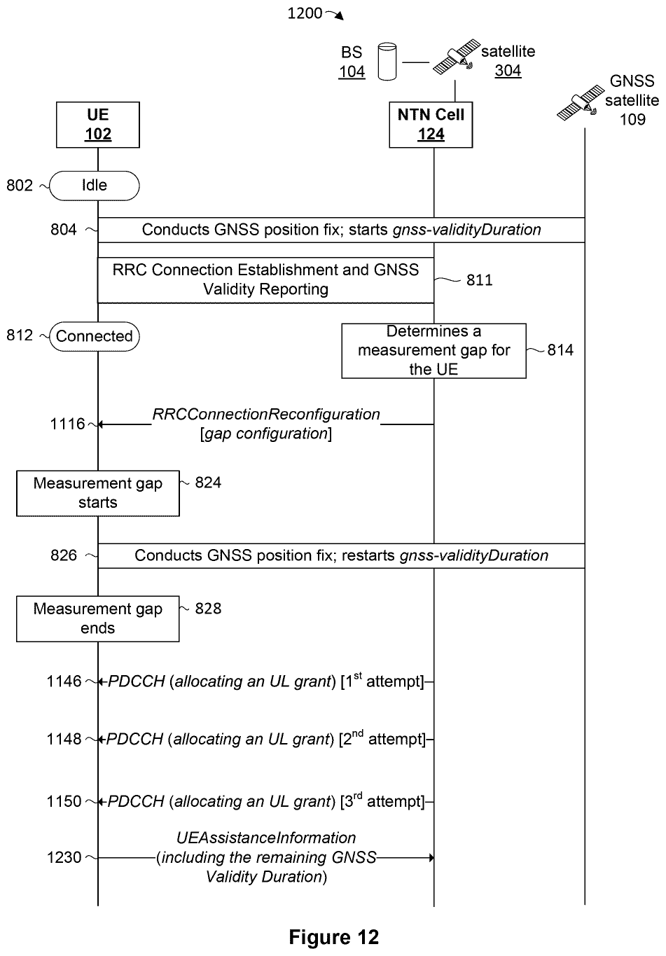

FIG. 11 is a messaging diagram 1100 of a scenario in which a UE fails to conduct the GNSS position fix procedure in a measurement gap, and hence a BS transitions the UE in an idle state upon receiving no GNSS validity report from the UE after the UL transmission opportunities, according to an embodiment. The message diagram in FIG. 11 (which corresponds to the timeline in FIG. 7C) is similar to that in FIGS. 8 and 9, with the differences discussed below. After the procedure 811 for RRC connection establishment and GNSS validity reporting, the BS 104 determines 1114 a measurement gap configuration for the UE 102 and optionally a number of UL transmission occasions to be provided to the UE 102 for reporting the GNSS validity duration. The BS 104 then transmits 1116, to the UE 102, an RRC message (e.g., RRC Connection Reconfiguration) including the determined measurement gap configuration and the determined number UL transmission occasions. In an alternative embodiment, the number of UL transmissions to be provided to a UE is a common predetermined value for all the UEs. Yet in another embodiment, the number of UL transmissions to be provided to a UE is a common configurable value that is broadcasted in an SIB (e.g., SIB31).

According to the measurement gap configuration that the BS has provided to the UE, the UE 102 suspends 824 its cellular communication tasks at the beginning of the measurement gap. The UE 102 then conducts 926 a GNSS position fix procedure during the measurement gap. In this scenario, the GNSS position fix procedure fails perhaps for a reasons previously discussed. After the measurement gap ends 828 and the UE 102 resumes its cellular communication tasks, the BS 104 then starts providing 1146, 1148, and 1150, to the UE 102, UL transmission opportunities (i.e., UL grants). The UE 102 could have used such an UL transmission opportunity to report a remaining GNSS validity duration. But because the GNSS position fix procedure failed, the UE 102 does not use any of these UL transmission opportunities to report the remaining GNSS validity duration. When UE's GNSS validity duration expires 936, the UE 102 transitions to the idle state.

On the BS side, in order to provide the three (the number determined at 1114) UL transmission opportunities to the UE 102, the BS 104 does not transition the UE 102 into the idle state when the GNSS validity duration timer expires but instead performs this transition later 1152 after receiving no GNSS validity duration in any of the UL transmission opportunities provided to the UE 102. In another embodiment, the BS 104 transitions the UE 102 into the idle state if either the GNSS validity duration timer of the UE 102 expires, or none of the UL transmission opportunities provided to the UE 102 carries a remaining GNSS validity duration.

FIG. 12 is a messaging diagram 1200 of a scenario in which a UE reports the GNSS validity duration shortly after a measurement gap using an UL transmission grant, according to an embodiment. The message diagram in FIG. 12 is similar to that in FIG. 11, with the differences discussed below. Unlike in FIG. 11, the UE 102 here conducts 826 a GNSS position fix procedure successfully during the measurement gap. Therefore, the UE restarts the gnss-validityDuration timer.

After the measurement gap ends 828, the UE 102 resumes its cellular communication tasks. The BS 104 starts providing a number of UL transmission opportunities (e.g., 3) to the UE 102 in the events 1146, 1148, and 1150, after the end of the measurement gap. In this example, upon receiving the 3^{rd} UL transmission opportunity from the BS 104, the UE 102 transmits 1230 the remaining GNSS validity duration to the BS 104 via an UL DCCH message (e.g., UEassistanceInformation). Because the UE 102 is able to inform the BS 104 of its remaining GNSS validity duration using the last UL transmission opportunity, the UE 102 remains in the connected state. Of course, the UE may use an earlier UL transmission opportunity.

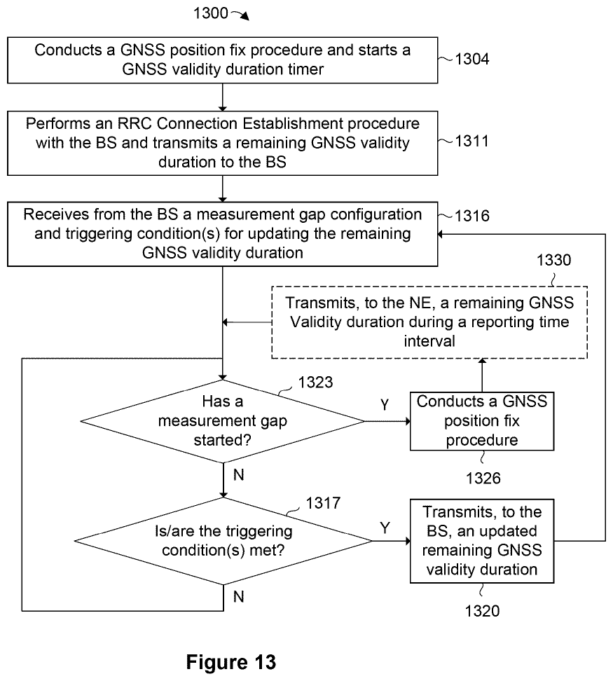

FIG. 13 a flow chart of a UE method 1300 for updating the GNSS validity duration and obtaining an updated measurement configuration in the connected state, according to an embodiment. The UE conducts 1304 a GNSS position fix procedure (as in 804) which may be triggered by a demand (from upper layers) for establishing the connection with a BS. The UE starts a GNSS validity duration timer upon successfully completing the GNSS position fix procedure.

After obtaining a valid GNSS position, the UE performs 1311 (as in 811) an RRC Connection Establishment procedure with a BS, and transmits the remaining GNSS validity duration (i.e., a current GNSS validity duration timer value to the BS). The UE then receives 1316 (as in 816) from the BS a measurement gap configuration and triggering condition(s) for updating the remaining GNSS validity duration. The measurement gap configuration may include a measurement gap length value, a measurement gap offset value, and/or a measurement gap repetition period value. The triggering conditions may include the triggering condition(s) parameters as described relative to FIG. 8.

When the UE determines 1323 that a measurement gap according to the BS-provided measurement gap configuration has started (i.e., “YES” branch of 1323 corresponding to 824), the UE conducts 1326 a GNSS position fix procedure during measurement gap and then (if the GNSS position fix procedure is completed successfully) transmits 1330 (corresponding to 830) a remaining GNSS validity duration to the BS. Otherwise (i.e., “No” branch of 1323), the UE determines 1317 whether the triggering condition(s) for updating the remaining GNSS validity duration has/have been met. If determined that the triggering condition(s) for updating the remaining GNSS validity duration has/have been met (i.e., “YES” branch of 1317), the UE transmits 1320 (corresponding to 820) an updated remaining GNSS validity duration to the BS after which the procedure returns to step 1316. The updated remaining GNSS validity duration may indicate an end of the GNSS validity duration earlier than a previously-received remaining GNSS validity duration, therefore causing the BS to schedule the measurement gap earlier. In one embodiment the UE may use a specific value (e.g., 0) to request the BS to schedule a measurement gap as soon as possible.

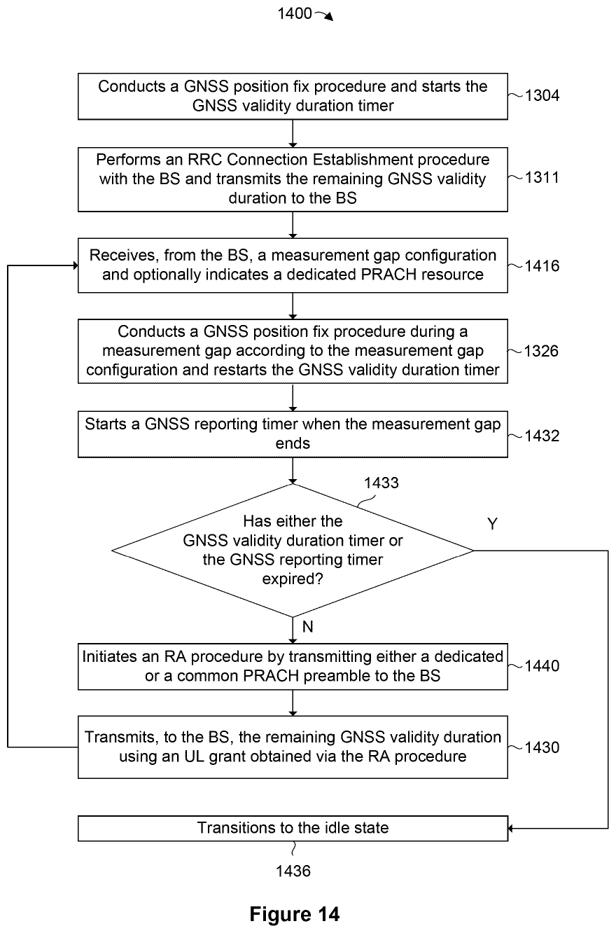

FIG. 14 is a flow diagram of a UE method 1400 for reporting a GNSS validity duration using a contention-free random access (RA) procedure according to an embodiment. Description of steps 1304, 1311, and 1326 is not repeated. After step 1311, the UE receives 1416, from the BS, a measurement gap configuration and optionally indicates (thereby is different from 1316) a dedicated PRACH resource (e.g., a dedicated PRACH preamble).

At the end of the measurement gap, the UE starts 1432 a GNSS reporting timer. The value of the GNSS reporting timer can be a predetermined fixed value, a configurable value broadcasted by the BS in a system information, or a configurable value transmitted together with the measurement gap configuration.

The UE then determines 1433 if either the GNSS validity duration timer or the GNSS reporting timer has expired. If any of the timers expired (i.e., ‘YES’ branch of 1433), the UE transitions 1436 to the idle state. If none of the timers expired (i.e., ‘NO’ branch of 1433), the UE initiates 1440 an RA procedure, by transmitting either a dedicated (if the UE has received an indication of a dedicated PRACH resource configuration at 1416) or a common PRACH preamble to the BS. The UE then transmits 1430, to the BS, the remaining GNSS validity duration (assuming the UE has obtained an UL transmission opportunity, that is, an UL grant after initiating the RA procedure at 1440). The UE then repeats step 1416 and following steps.

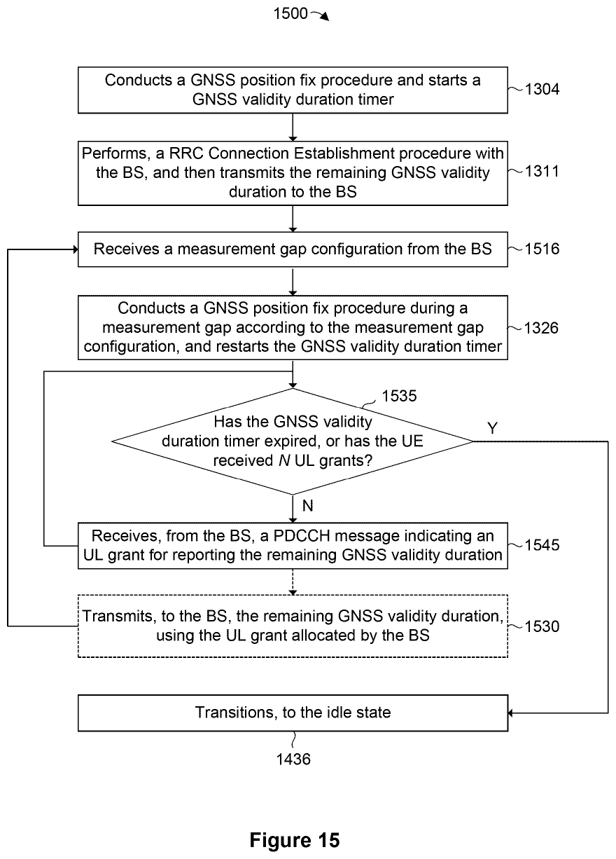

FIG. 15 is a flow diagram of a UE method 1500 for reporting a GNSS validity duration using the UL transmission opportunities, after a measurement gap, according to an embodiment. The flow diagram in FIG. 15 is similar to that in FIG. 14, with the differences discussed below. Description of steps 1304, 1311, and 1326 is not repeated. After step 1311, the UE receives 1516, from the BS, a measurement gap configuration (without triggering conditions as in 1316 or indicating a dedicated PRACH resource as 1416). After conducting 1326 a GNSS position fix procedure during a measurement gap according to the measurement gap configuration and restarting the GNSS validity duration timer upon successfully completing the GNSS position fix procedure, the UE determines 1535 whether the GNSS validity duration timer has expired, or the UE has already received N UL transmission opportunities (e.g., UL grants) from the BS. The W value may be a predetermined fixed value, a configurable value broadcasted by the BS in a system information, or a configurable value transmitted together with the measurement gap configuration. If the result of the determination 1535 is ‘YES’, the UE transitions 1436 to the idle state. If the result of determination 1535 is ‘NO’, the UE receives 1545, from the BS, a physical downlink control channel (PDCCH) message indicating an UL transmission opportunity (e.g., an UL grant) for reporting the remaining GNSS validity duration. The UE then transmits 1530, to the BS, the remaining GNSS validity duration using the UL transmission opportunity (when there is no other higher-priority traffic to be transmitted). In an alternative embodiment, the UE may decide whether to transmit the remaining GNSS validity duration to the BS using the current UL transmission opportunity provided by the BS (i.e., skips the entire block 1530), and may waits for the next UL transmission opportunity (i.e., back to 1535). Note that if the GNSS position fix procedure at 1326 was not completed successfully, the UE does not perform step 1530. When the UE has transmitted 1530 an updated GNSS validity duration to the BS, the flow goes back to the block 1516, where the UE will receive from the BS an updated measurement gap configuration.

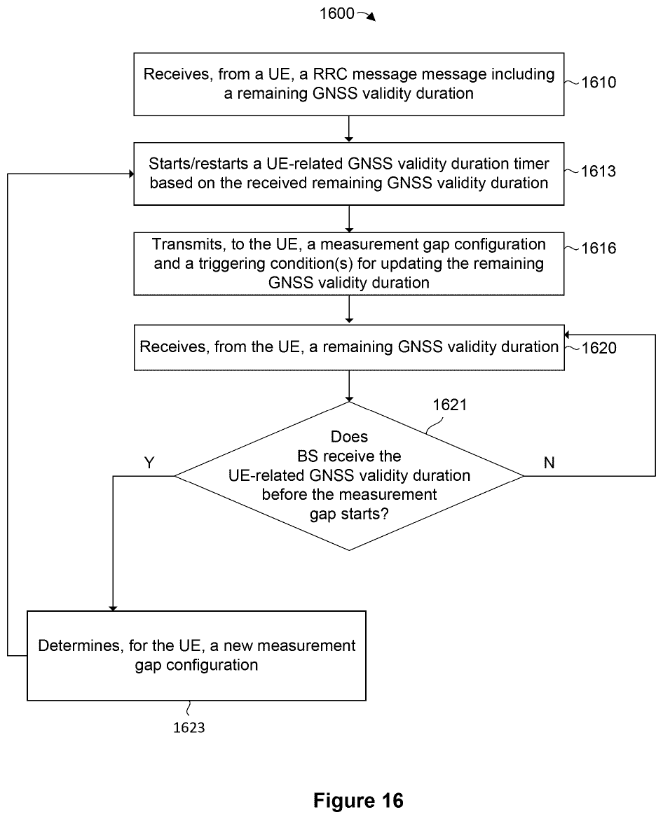

FIG. 16 is a flow diagram of an NE (e.g., a BS or a different network entity) method for determining an updated measurement gap configuration for a UE based on an updated GNSS validity duration according to an embodiment. The NE first receives 1610 (corresponding to 810), from a UE, an RRC message (e.g., UE Assistance Information message, Connection Setup Complete message) including a remaining GNSS validity duration and starts/restarts 1613 a UE-related GNSS validity duration timer. The NE then transmits 1616 (corresponding to 816), to the UE, a measurement gap configuration and the triggering condition(s) for updating the GNSS validity duration. The NE receives 1620 (corresponding to 820), from the UE, a remaining GNSS validity duration.

The NE then determines 1621 whether receiving the remaining GNSS validity duration has occurred before the beginning of a measurement gap or after the end of the measurement gap (as the UE does not communicate during the measurement gap). In one embodiment, the NE determines 1621 whether receiving the remaining GNSS validity duration has occurred before or after the beginning of a measurement gap (assuming the UE may be able to resume the cellular communication with the BS once the GNSS position fix procedure is completed). If the NE determined that the GNSS validity duration arrived before the beginning of the measurement gap (i.e., the ‘YES’ branch of 1621), the NE determines 1623 a new measurement gap configuration for the UE and then returns to 1616, where the NE transmits the new measurement gap configuration to the UE. Otherwise (i.e., the ‘NO’ branch of 1621), the NE returns to step 1613.

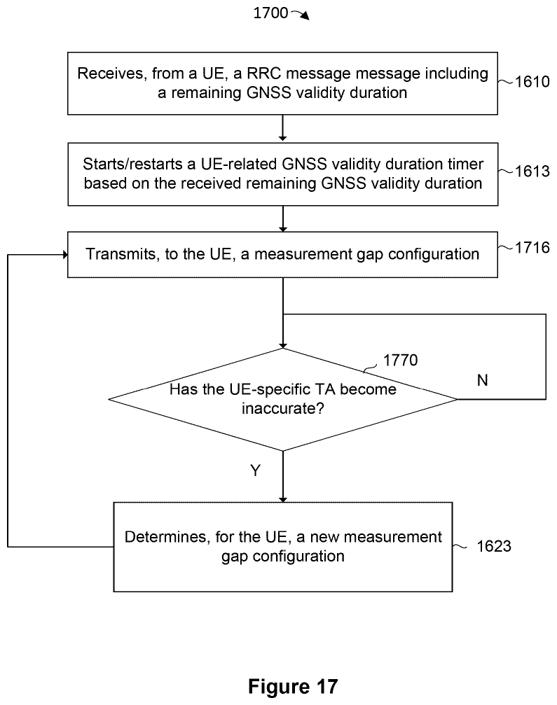

FIG. 17 is a flow diagram of another NE method 1700 for determining whether the UE-specific TA has become inaccurate and whether to update the measurement gap configuration for the UE accordingly, according to an embodiment. The first steps 1610 and 1613 of flow diagram in FIG. 17 are similar to that in FIG. 16 and therefore these steps'descriptions are not repeated. After step 1613, the NE transmits 1716, to the UE, a measurement gap configuration without the triggering condition(s). The NE then determines 1770 whether the UE-specific TA of the UE has become inaccurate. In one embodiment, the NE determines that the UE-specific TA of the UE has become inaccurate, based on whether the accumulated TA adjustment (e.g., the accumulated TAC values) that the NE has sent to the UE has exceeded a certain accumulated TA threshold value. In another embodiment, the NE determines that the UE-specific TA of the UE has become inaccurate based on the historic record of the TA reports transmitted by the UE. If the result of the decision 1770 is ‘YES’, the NE determines 1623 a new measurement gap configuration for the UE and transmits 1716 the new measurement gap configuration to the UE. Otherwise (the ‘NO’ branch of 1770), the NE takes no action periodically repeating 1770.

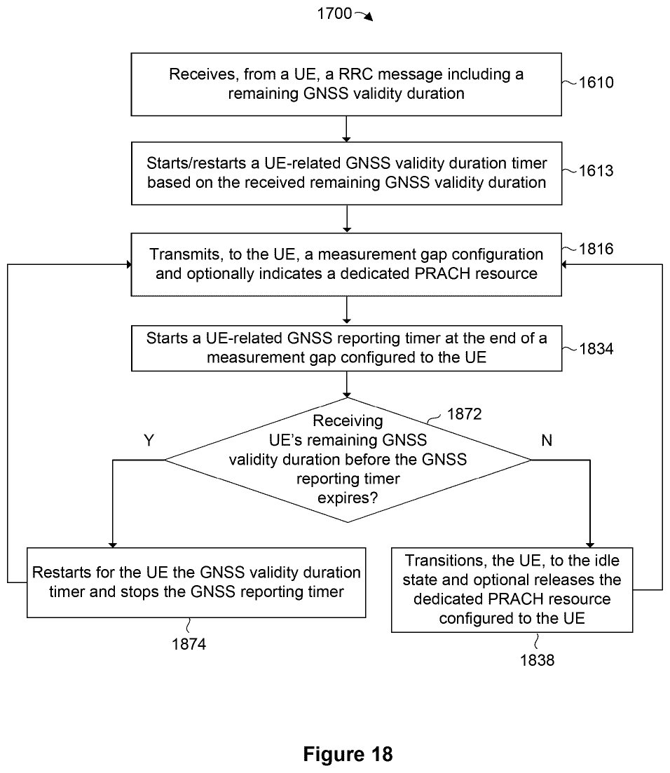

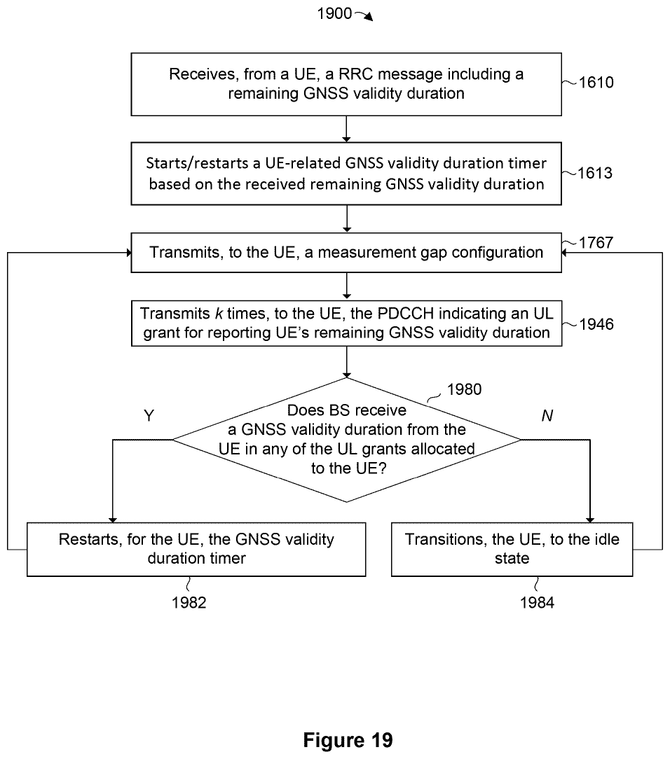

FIG. 18 is a flow diagram of an NE method 1800 for determining the PRACH resource and a GNSS reporting timer for a UE to report a remaining GNSS validity duration after a measurement gap ends according to an embodiment. The first steps 1610 and 1613 of flow diagram in FIG. 18 are similar to that in FIG. 16 and therefore these steps'descriptions are omitted. The NE transmits 1816, to the UE, a measurement gap configuration and optionally indicates a dedicated PRACH resource. The NE starts 1834 (which corresponds to 934) a UE-related GNSS reporting timer at the end of a measurement gap configured for the UE. The GNSS reporting timer value may be a predetermined fixed value, a configurable value broadcasted by the NE in a system information, or a configurable value transmitted together with the measurement gap configuration.

The NE then determines 1872 whether the NE has received a remaining GNSS validity duration from the UE before the UE-related GNSS reporting timer expires. If the result of the decision 1872 is ‘YES’, the NE restarts 1874 a UE-related GNSS validity duration timer on the received remaining GNSS validity duration and stops the GNSS reporting timer. On the other hand, if the result of the decision 1872 is ‘NO’, the NE transitions 1838 (corresponding to 938) the UE into the idle state and may (optional) release the dedicated PRACH resource if that resource has been configured to the UE earlier.

FIG. 19 is a flow diagram of an NE method 1900 for providing UL transmission opportunities used by a UE to report a GNSS validity duration after a measurement gap ends according to an embodiment. Steps 1610, 1613, and 1716 of flow diagram in FIG. 19 are the same as in FIGS. 16 and 17 and therefore these steps'descriptions are omitted. After step 1716, the NE transmits 1946 k times, to the UE, PDCCH messages indicating each an UL grant usable for reporting UE's remaining GNSS validity duration. The value k may be a predetermined fixed number, a configurable number broadcasted by the NE in a system information, or a configurable number transmitted together with the measurement gap configuration.

The NE then determines 1980 whether the remaining GNSS validity duration arrived from the UE in any of the UL grants allocated to the UE. If the result of the decision block 1980 is ‘YES’, the NE restarts 1982 the UE-related GNSS validity duration timer based on the received remaining GNSS validity duration. On the other hand, if the result of the decision block 1980 is ‘NO’, the NE transitions 1984 the UE to the idle state.

The following considerations may be applied to the descriptions above.

Generally speaking, description for one of the above figures can apply to another of the above figures. Any event or block described above can be optional. For example, an event or block with dashed lines can be optional.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise. As used herein, a phrase referring to “at least one of” or “one or more of” a list of items refers to any combination of those items, including single members. For example, “at least one of: a, b, or c” is intended to cover the possibilities of: a-only, b-only, c-only, a combination of a and b, a combination of a and c, a combination of b and c, and a combination of a and b and c.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A wireless communication method performed by a user equipment, UE, connected to a network entity, NE, via a non-terrestrial network, the method comprising:
receiving, from the NE, a measurement gap configuration and an indication of a validity-duration-update triggering condition;
conducting a Global Navigation Satellite System, GNSS, position fix procedure for estimating a UE position during a measurement gap according to the measurement gap configuration; and
transitioning from a connected state to an idle state after the remaining GNSS validity duration ends when the GNSS position fix fails.

19. The wireless communication method of claim 18, further comprising:
transmitting, to the NE, a remaining GNSS validity duration when the GNSS position fix procedure is successfully completed; and
transmitting, to the NE, an updated remaining GNSS validity duration with a different end time than the remaining GNSS validity duration when the validity-duration-update triggering condition is met.

20. The wireless communication method of claim 19, further comprising:
receiving, from the NE, a timing advance, TA, adjustment value of the TA applied to any uplink transmission,
wherein the validity-duration-update triggering condition is based on one or more recent TA adjustment values or on a number of the TA adjustment values received within a given time interval.

21. The wireless communication method of claim 20, wherein the validity-duration-update triggering condition is met when a TA adjustment value most recently-received exceeds a TA threshold value.

22. The wireless communication method of claim 20, further comprising:
maintaining an accumulated TA adjustment based on one or more recent TA adjustment values received over a predetermined time interval, wherein the validity-duration-update triggering condition is met when the accumulated TA adjustment exceeds a TA accumulated adjustment threshold.

23. The wireless communication method of claim 20, wherein the validity-duration-update triggering condition is met when on a number of the receiving the TA adjustment value within a given time interval exceeds a number threshold.

24. The wireless communication method of claim 18, wherein the receiving includes receiving a dedicated physical random access channel, PRACH, preamble indication usable for the UE to request an uplink grant for the transmitting of the remaining GNSS validity duration, or receiving one or more uplink grants usable for the transmitting of the remaining GNSS validity duration.

25. A wireless communication method performed by a network entity, NE, the method comprising:
transmitting, to a user equipment, UE, connected to the NE via a non-terrestrial network, a measurement gap configuration and an indication of a validity-duration-update triggering condition for the UE to update a Global Navigation Satellite System, GNSS, validity duration of a GNSS position fix procedure;
starting a GNSS reporting timer when a configured measurement gap ends; and
transitioning the UE to an idle state when a remaining validity GNSS duration has not been received before the GNSS reporting timer expires.

26. The wireless communication method of claim 25, further comprising:
upon receiving, from the UE, the remaining validity GNSS duration before the GNSS reporting timer expires, if the remaining validity GNSS duration ends before a next measurement gap according to the measurement gap configuration, determining and transmitting, to the UE, an updated measurement gap configuration.

27. The wireless communication method of claim 26, wherein the transmitting the measurement gap configuration includes:
transmitting, to the UE, a dedicated physical random access channel, PRACH, preamble indication usable by the UE to report the remaining GNSS validity duration, or repeatedly transmitting, to the UE, an uplink grant usable by the UE to report the remaining GNSS validity duration.

28. The wireless communication method of claim 25, further comprising:
upon receiving the remaining GNSS validity duration before the GNSS reporting timer expires, stopping the GNSS reporting timer and maintaining the UE in connected state.

29. The wireless communication method of claim 25, further comprising:
transmitting, to the UE, a UE-specific timing advance, TA, value for the UE to apply to any uplink transmission according to a current distance between the UE and a satellite.

30. The wireless communication method of claim 29, further comprising:
determining an updated measurement gap configuration when a UE-specific timing advance, TA, has become inaccurate.

31. The wireless communication method of claim 30, wherein the UE-specific TA, has become inaccurate when an accumulated TA adjustment exceeds a predetermined threshold, or an evolution of the UE-specific TA differs from historical data.

32. A user equipment, UE, comprising:
a transceiver configured to exchange messages with a network entity, NE, via a non-terrestrial network; and
a processor controlling the transceiver and configured
to receive, from the NE via the transceiver, a measurement gap configuration and an indication of a validity-duration-update triggering condition;
to conduct, using the transceiver, a Global Navigation Satellite System, GNSS, position fix procedure for estimating a UE position during a measurement gap according to the measurement gap configuration; and
to transition the UE from a connected state to an idle state after the remaining GNSS validity duration ends when the GNSS position fix fails.

33. The UE of claim 32, wherein the processor is further configured to control the transceiver:
to transmit, to the NE using the transceiver, a remaining GNSS validity duration when the GNSS position fix procedure is successfully completed; and
to transmit, to the NE using the transceiver, an updated remaining GNSS validity duration with a different end time than the remaining GNSS validity duration when the validity-duration-update triggering condition is met.

34. The UE of claim 33, wherein the processor is further configured to receive, from the NE via the transceiver, a timing advance, TA, adjustment value of the TA applied to any uplink transmission,
wherein the validity-duration-update triggering condition is based on one or more recent TA adjustment values or on a number of the TA adjustment values received within a given time interval.

35. The UE of claim 34, wherein
the validity-duration-update triggering condition is met when a TA adjustment value most recently-received exceeds a TA threshold value,
the validity-duration-update triggering condition is met when an accumulated TA adjustment exceeds a TA accumulated adjustment threshold, the accumulated TA adjustment being based on one or more recent TA adjustment values received over a predetermined time interval, and/or
the validity-duration-update triggering condition is met when on a number of the receiving the TA adjustment value within a given time interval exceeds a number threshold.

36. A network entity comprising:
a transceiver configured to exchange messages with a user equipment, UE, via a non-terrestrial network; and
a processor configured to control the transceiver and
to transmit, to the UE using the transceiver, a measurement gap configuration and an indication of a validity-duration-update triggering condition for the UE to update a Global Navigation Satellite System, GNSS, validity duration of a GNSS position fix procedure;
to start a GNSS reporting timer when a configured measurement gap ends; and
to transition a UE state to an idle state when a remaining validity GNSS duration has not been received before the GNSS reporting timer expires.

37. The NE of claim 36, wherein upon receiving, from the UE via the transceiver, the remaining validity GNSS duration before the GNSS reporting timer expires, if the remaining validity GNSS duration ends before a next measurement gap according to the measurement gap configuration, the processor determines and transmits, to the UE using the transceiver, an updated measurement gap configuration.
